(19) United States
(12) Patent Application Publication
(10) Pub. No.: US 2011/0246462 A1
(43) Pub. Date: Oct. 6, 2011

(54) Method and System for Prompting Changes of Electronic Document Content

(75) Inventors: Xian Wu, Jiangsu Province (CN); Quan Yuan, Beijing (CN); Xia Tian Zhang, (US); Shiwan Zhao, (US)

(73) Assignee: INTERNATIONAL BUSINESS MACHINES CORPORATION, Armonk, NY (US)

(21) Appl. No.: 13/074,182

(22) Filed: Mar. 29, 2011

(30) Foreign Application Priority Data
Mar. 30, 2010 (CN) 201010136975.9

(51) Int. Cl. G06F 17/30

(52) U.S. Cl. 707/736; 707/E17.045; 707/E17.046

(57) ABSTRACT

A method and system for prompting changes of electronic document content. The method includes the steps of: determining a first relation information from a first document where the first relation information includes: a first named entity, a second named entity, and a first relationship between the first named entity and the second named entity, storing the first relation information in a database, determining a second relation information from a second document, where the second relation information includes: a third named entity, a fourth named entity, and a second relationship between the third named entity and the fourth named entity, retrieving the first relation information from a database, and sending the first relation information to a client, if the first relation information is different from the second relation information, where at least one step is performed using a computer device.

### CROSS-REFERENCE TO RELATED APPLICATION

This application claims priority under 35 U.S.C. §119 from Chinese Patent Application No. 201010136975.9 filed Mar. 30, 2010, the entire contents of which are incorporated herein by reference.

### BACKGROUND OF THE INVENTION

In the world where information grows rapidly, there are a large number of electronic documents, including massive web pages on the Internet, electronic documents accumulated through OCR (optical character recognition) technology and the like. Through various applications, users can acquire a variety of information very conveniently. For example, search engines can help users to retrieve various related electronic documents to facilitate user reading and using.

However, while users are concerned about the amount of information provided by existing various applications, they are also highly concerned about the quality of information. Especially nowadays, the Internet has entered the era of Web 2.0, and there is not only information from authoritative news organizations or large companies, but also a huge amount of information provided by individual users; thus the quality of information differs greatly. In addition, as information of various documents continuously changes over time, information of related electronic documents read by readers might be outdated. If users make judgments or take actions based on the outdated information, usually counterproductive results can be caused. In addition, sometimes users want to know past information changes of documents; however, currently, there is no corresponding technology that quickly and easily meets the related requirements of users.

### SUMMARY OF THE INVENTION

One aspect of the present invention includes a method for prompting changes of electronic document content. The method including the steps of: determining a first relation information from a first document where the first relation information includes: a first named entity, a second named entity, and a first relationship between the first named entity and the second named entity, storing the first relation information in a database, determining a second relation information from a second document, where the second relation information includes: a third named entity, a fourth named entity, and a second relationship between the third named entity and the fourth named entity, retrieving the first relation information from a database, and sending the first relation information to a client, if the first relation information is different from the second relation information, where at least one step is performed using a computer device.

Another aspect of the present invention is an electronic data processing system for prompting changes of an electronic document. The system includes: determining means configured to determine: a first relation information from a first document, where the first relation information includes: a first named entity, a second named entity, and a first relationship between the first named entity and the second named entity, and a second relation information from a second document, where the second relation information includes: a third named entity, a fourth named entity, and a second relationship between the third named entity and the fourth named entity, storing means configured to store the first relationship in a database, retrieving means configured to retrieve the first relation information from the database, and sending means configured to send the first relation information to the client, if the first relation information is different from the second relation information.

### BRIEF DESCRIPTION OF THE DRAWINGS

The following drawings will be taken reference to in order to specify features and advantages of embodiments of the present invention. If possible, same or similar parts in the drawings and description are referred to with same or similar reference signs, where:

FIG. 1 shows the first specific embodiment for prompting changes of an electronic document content;

FIG. 2 shows the second specific embodiment for prompting changes of an electronic document content;

FIG. 3 shows the third specific embodiment for prompting changes of an electronic document content;

FIG. 4 shows a specific embodiment for establishing a relation information change history database;

FIG. 5 shows the fourth specific embodiment for prompting changes of an electronic document content;

FIG. 6 shows a specific application example;

FIG. 7 shows a structural block diagram of a system for prompting changes of an electronic document content; and

FIG. 8 shows a structural block diagram of a system for establishing a relation information change history database.

### DETAILED DESCRIPTION OF THE INVENTION

The invention will now be described in detail with reference to exemplary embodiments, and examples of the embodiments are illustrated in the drawings, in which same reference numbers refer to the same elements. It should be understood that the invention is not limited to the disclosed example embodiments. It should also be understood that not every feature of the method and means is necessary to perform the invention sought to be protected by any claim. In addition, in the whole disclosure, when a process or method is shown or described, steps of the method can be performed in any order or simultaneously, unless it is obvious from the context that one step depends on another one which is previously performed. Furthermore, there can be significant time intervals between steps.

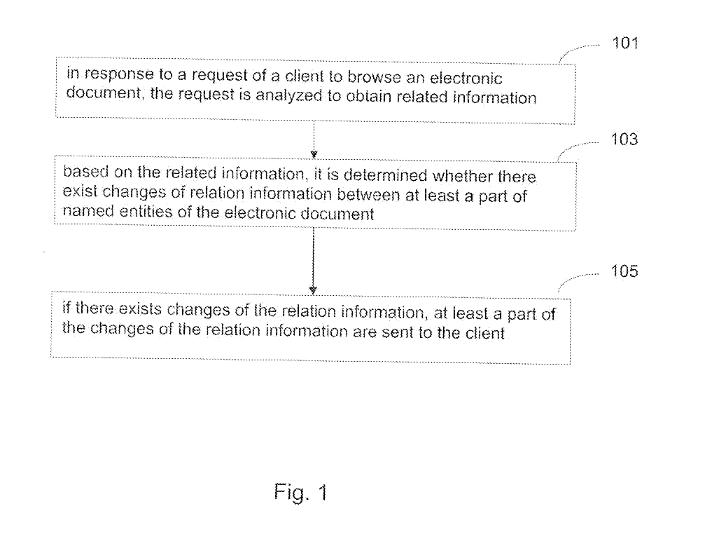

Referring to FIG. 1, the first embodiment for prompting changes of electronic documents of the invention is described in detail. In step 101, in response to a request of a client to browse an electronic document, the request is analyzed to obtain related information. For example, a user can submit a request to browse an electronic document by clicking a related link of a related web site, or submitting a storage path of the electronic document to be browsed in applications, etc. The step of analyzing the request to obtain the related information can include analyzing the request to obtain URL (Uniform Resource Locator) of the electronic document, the storage path, Global Unique Code of the electronic document, or another form of unique identifier of the electronic document. Analyzing the request to obtain the related information can also include performing Named Entity Recognition on the electronic document based on the request of the user to obtain the electronic document, to obtain the requested related information such as related named entities of the electronic document and the like.

Herein, Named Entity Recognition refers to automatic recognition of entities with particular meanings in text (if the electronic document is not in the form of text, it can be converted into text format through multiple existing tools), such as date, number, name, organization name, chemical name, etc. Named Entity Recognition problems can be defined as classification problems, i.e., every word belongs to a pre-defined class representing regional location information.

{wᵢ} i=0, 1, K, m can be used to represent Token sequence of the text for the purpose of allocating a class label tᵢ to each text symbol wᵢ, and the value for tᵢ is a predefined class label set. A Traditional BIO coding system is generally used as class tags of text symbols. Herein, B means that the current word is an initial portion of a name, I means that the current word is a portion of the name but not the initial portion, and O means that the current word is not a portion of the name. The task of a learning system is to predict a class label tᵢ of each text symbol wᵢ.

Existing named entity recognition methods can be roughly classified into three kinds: dictionary-based, rule-based and machining learning-based. The current learning-based system has become a mainstream of NER gradually, which can be further classified into two classes: classifier-based system and Markov model-based system. The former includes Support Vector Machine 0, etc; the latter includes HMM0, MEMM0, CRF0, etc., and is advantageously prominent in addressing sequence tagging issues such as speech recognition and speech tagging. Details can be found in [1] LEEK, “Information Extraction Using Hidden Markov Models”, Master's thesis, UC San Diego, 1997; [2] McCALLUM et al., “Maximum Entropy Markov Models for Information Extraction and Segmentation,” Proc. ICML 2000, pp. 591-98, Stanford, Calif.; [3] McCALLUM et al., “Conditional Random Fields: Probabilistic Models for Segmenting and Labeling Sequence Data,” In Int. Conf. on Machine Learning, 2001; and [4] CRISTIANINI et al., “An Introduction to Support Vector Machines and Other Kernel-Based Learning Methods,” Cambridge University Press, 2000.

In the present invention, named entity recognition is used to find and locate names, addresses, dates and other information in an unstructured document. For specific named entity recognition methods, no further description is given here, and the above specific named entity recognition method is merely exemplary without any limitation to the scope of protection of the invention.

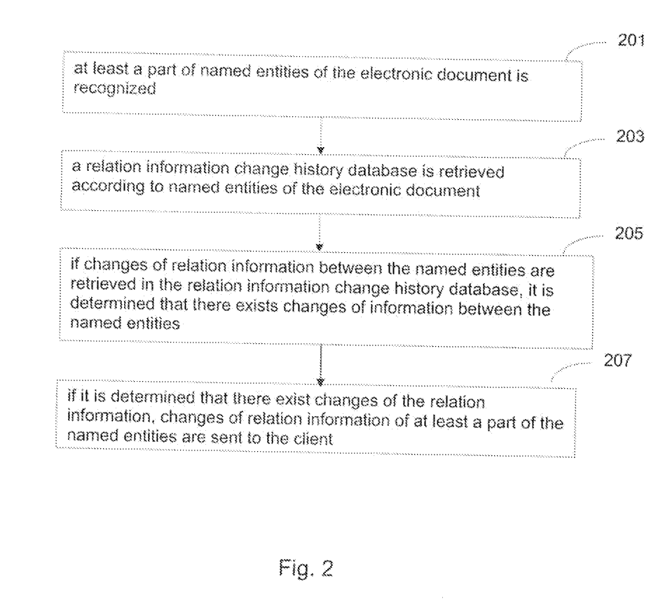

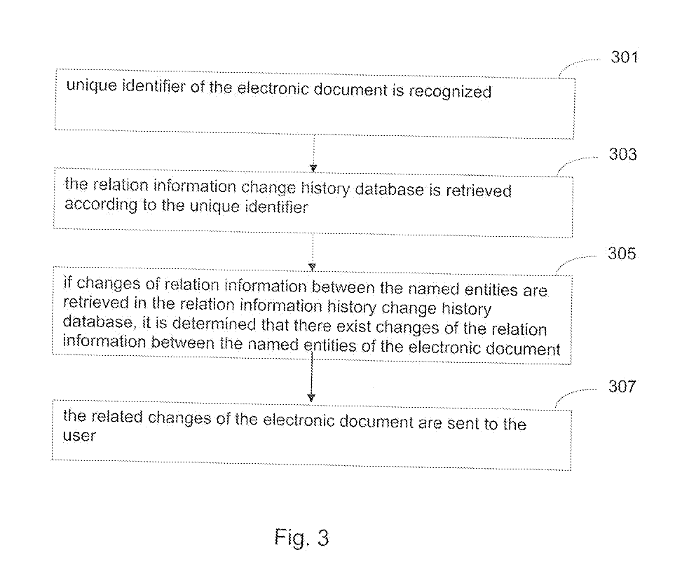

In step 103, based on the related information obtained in step 101, it is determined whether there exist changes of relation information between named entities of the electronic document. Herein, there are many embodiments in the present invention for determining whether there exist changes of relation information between named entities of the electronic document. Preferably, based on the present application, change information of relation information between various named entities of an electronic document can be stored as a database, the database can be retrieved based on retrieval conditions by analyzing named entities of the electronic document, or change prompts of the electronic document are stored into a database in advance and a unique identifier of the electronic document is recorded, and then based on the unique identifier of the electronic document, at least the change information is sent to a client. FIGS. 2 and 3 show two preferred embodiments, and specific details thereof will be described in the discussion of FIGS. 2 and 3. Those skilled in the art can conceive of other embodiments based on the present application.

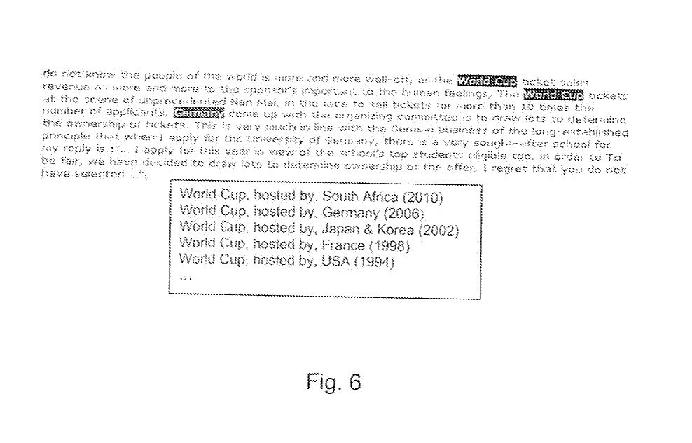

In step 105, if there are changes of the relation information, at least the changes of the relation information are sent to the client. If in step 103, it is decided that there are changes of the relation information between named entities of the electronic document, changes of relation information between named entities are determined and such changes are sent to the client. At the client, the user can be prompted in manners of floating prompt bar, modifying tag, transparent display, etc. Through these prompt manners, change history of information can be presented when the user browses web pages by adding functional plug-ins at the client's browser or using Javascript script language. FIG. 6 shows a specific application of the present invention, (as will be discussed in greater detail below).

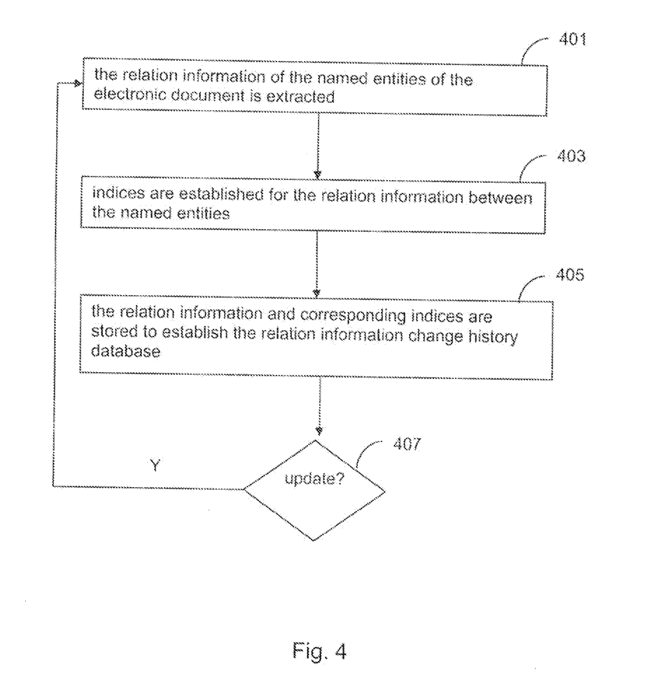

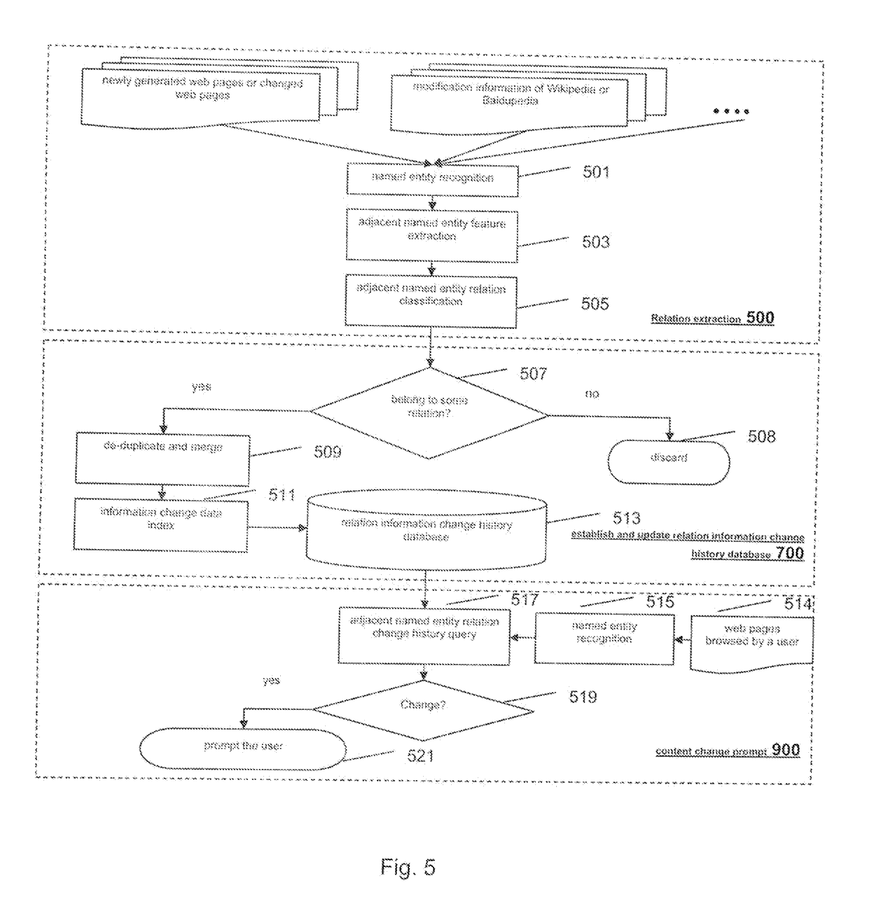

FIG. 2 shows the second specific embodiment of the method for prompting changes of electronic document content of the present invention. Herein, in step 201, at least a part of the named entities of the electronic document are recognized. In this step, named entity recognition can be performed by using the above described various named entity recognition methods, and thus multiple named entities of the electronic document can be obtained, preferably including at least two adjacent named entities, such as two named entities in the same sentence. In step 203, the relation information change history database is retrieved based on the named entities of the electronic document. Where, two adjacent named entities can be taken as retrieval conditions to retrieve the relation information change history database, preferably, the relation information change history database is indexed to shorten retrieval time and improve retrieval efficiency. The relation information change history database can be established through various manners based on the present application. FIGS. 4 and 5 show preferred manners of establishing the relation information change history database, which will be described in detail later.

In step 205, if changes of relation information between the named entities are retrieved in the relation information change history database, it is determined that there exist changes of the relation information between the named entities. In the relation information change history database, relation information of the named entities of the electronic document will be recorded; for example, relation information change history of the named entities is recorded by a quaternary characterizing relation information such as <subject, relation, object, time> and is indexed. The relation information is not limited to the content above, and the user can also define related information of interest. The relation information can also be expressed by using other different data structures. In step 207, if it is determined in step 205 that there exist changes of the relation information, at least the changes of the relation information of the at least a part of the named entities is sent to the client. The second embodiment shown in FIG. 2 can implement prompting of any form of electronic document browsed by the user, and it has no any special requirement on the format of the electronic document and greatly extends user requirements on high-quality information of a large number of documents.

FIG. 3 shows the third specific embodiment of the method for prompting changes of electronic documents of the present invention. Herein, in step 301, a unique identifier of the electronic document is recognized. The URL of the electronic document, the storage path, the global unique code of the electronic document or another form of unique identifier of the electronic document can be used as the unique identifier of the electronic document; the unique identifier of the electronic document can exist in the request of the user, it can also be in an accessed content server, and it can be obtained by those skilled in the art using various analyzing means based on the present application.

In step 303, the relation information change history database is retrieved according to the unique identifier. In the relation information change history database, there are stored the electronic document identified by the unique identifier and the prompted changes of the relation information between named entities. Indices of retrieval of the database can be established by the unique identifier of the electronic document.

In step 305, if changes of relation information between the named entities are retrieved in the relation information change history database, it is determined that there exist changes of the relation information between the named entities of the electronic document. That is, if a retrieval entry for the unique identifier which is obtained by analyzing the request of the client is found in the relation information change history database, and this retrieval entry records the electronic document and the changes of the relation information between the named entities of the electronic document, then it is determined that there exist changes of the relation information between the named entities of the electronic document.

In step 307, the related changes of the electronic document are sent to the user. Since the retrieval entry recording the electronic document and the changes of the relation information between the named entities of the electronic document has been retrieved, the related changes of the electronic document can be sent to the user. Preferably, if the service provider itself owns copyright of the electronic document or the right of using the copyright, the electronic document can also be sent to the user simultaneously, without requesting the third party for the electronic document. One of the above multiple prompt manners is used for presentation to the user so as to ensure the user gets information closest to reality, or the latest information, or that the user gets to know the change history of the relation information between the named entities, thereby greatly improving the user's use experience and having significant technical effect. Incorporation of the approach into search engine tools such as Google and Baidu will allow the user to have a better experience.

FIG. 4 shows a specific embodiment of the present invention for establishing the relation information change history database. Herein, in step 401, the relation information of the named entities of the electronic document is extracted. Herein, it includes recognition of the named entities of the electronic document, as well as recognition and classification of the relation information between adjacent named entities. The relation information can be a quaternary, including named entities of subject and object, relation between named entities and time information. In step 403, indices are established for the relation information between the named entities. In order to improve query efficiency, related indices should be established for the relation information.

Preferably, it can be decided whether there exists changes of relation information between corresponding named entities in the electronic document based on time information, and if so, the electronic document with changed tags is formed and stored, and related indices are established based on the unique identifier of the electronic document, named entities, and relation between named entities. Preferably, de-replication and merging of the relation information between the named entities are also included. In step 405, the relation information and corresponding indices are stored to establish the relation information change history database. The relation information change history database can be initially established through the above method. As the electronic document will increase continuously over time and information within the electronic document will change continually, in step 407, it is decided whether to change the established relation information history database periodically, and if so, the above steps 401, 403 and 405 are repeated to ensure capability of providing timely changed information to the user.

FIG. 5 shows the preferred fourth specific embodiment of prompting changes of the electronic document of the present invention, in which three main steps are included: step 500 of extracting relation information between named entities of a plurality of the electronic documents; step 700 of establishing the relation information change history database based on the relation information; and step 900 of content change prompting. Herein, those skilled in the art know that a large number of newly generated web pages or changed web pages, modification information of Wikipedia or Baidupedia, etc., can be collected through web crawler, and other type of electronic documents can also be collected in other manners.

In step 501, multiple electronic documents are received, and the named entities in the electronic documents are recognized. In step 503, related features of the adjacent named entities are extracted. In this step, time information of the electronic documents can be extracted, and it can be obtained through many technical means like extracting time stamps of the electronic documents, recognizing dates recorded in the electronic documents, etc. It should be noted that extracting time information of documents can be performed in any appropriate step, without special requirements on sequence. Feature Extraction refers to extracting features from texts and quantifying them into computer-understandable abstract expressions. In machining learning methods, appropriate feature extraction can greatly increase accuracy of machining learning models; for example, when a POS (Part-Of-Speech) classifier is trained. The first step is feature selection, which mainly focuses on two kinds of features here. The first one is features of a word itself, for example, whether the word is capitalized, whether it is digital, whether it is all uppercase, whether it is full of numbers, prefixes and suffixes, etc. The second one is context features, for example, words before and after a word, part of speech of previous word, and so on. Based on these features, a machining learning model can be constructed, and parameters of this model are obtained by training on marked data sets, for predicting unmarked data sets.

In the present invention, named entity recognition is performed first in a document; for two adjacent named entities (for example, appearing in the same sentence), the following features can be extracted for deciding the relation between the two entities:

(1) native features of the entities: names of the entities, classes of the entities, parts of speech of the entities, etc.;

(2) relation features of the entities: the distance between the two entities in number of words, whether there are consecutive verbs in the entities, verb's etyma, etc.;

(3) context features: words around the two entities.

It should be noted that the above method of feature extraction is only exemplary, and those skilled in the art can use existing related methods or related methods to be found in the future based on the present invention, which methods do not limit the protection scope of the present invention. Other specific methods can also use Latent Dirichlet Allocation to obtain implicit features, see BLEI et al., “Latent Dirichlet Allocation,” Journal of Machine Learning Research, Volume 3, pp. 993-1022, Mar. 1, 2003. As an example, if there is a related electronic document describing the address issue of IBM China Research Lab, after the above steps, relation quaternaries as <IBM China Research Lab, located in, Haohai Building, 2003> and <IBM China Research Lab, situated in, Diamond Building, 2005> characterizing relation information between named entities can be obtained.

In step 505, based on the above features, relations of adjacent named entities are classified. After obtainment of the two adjacent named entities, relation extraction is to decide the relation between them, such as “located in”, “take office” and so on. For each relation, the above-mentioned feature extraction method is used to train a classification model on data sets marked in advance. That is to say, one classifier is trained for each relation. For two adjacent named entities, each classifier is used for relation prediction to find the class with highest accuracy, and if the accuracy exceeds a threshold, it is considered that the two entities comply with the relation; otherwise it is considered that the two entities have no relation. The method of feature extraction is merely exemplary, and those skilled in the art can use existing related methods or related methods to be found in the future based on the present invention, which methods do not limit the protection scope of the present invention.

Other specific methods can also use grammatical structures for extraction, for example, with reference to SAHAY et al., “Discovering Semantic Biomedical Relations Utilizing the Web,” Journal: ACM Transactions on Knowledge Discovery from Data, Volume 2, Issue 1, Mar. 3, 3008, pp. 1-15. After the above classification steps, corresponding relation information can be obtained, which can be expressed as relation quaternaries as <subject, relation, object, time>, for example, <IBM China Research Lab, situated in, Haohai Building, 2003> and <IBM China Research Lab, situated in, Diamond Building, 2005> will belong to the same class, because the “located in” and “situated in” are relations expressing address. It should be noted that the above relation quaternaries are just exemplary, and those skilled in the art can definitely conceive of any other appropriate data structures to express the relation information based on the application.

Step 700 of establishing and changing the information change history database has a plurality of steps. Herein, in step 507, it is decided whether relations between the classified adjacent named entities belong to predefined relation classes. There can be many types of predefined relations, such as “hosted at”, “take office” and “superior-subordinate relationship”, or a user can specify predefined relation types of interest to meet his special demands. If the relations between the named entities do not belong to predefined relation classes, such relation information will be discarded. If the relations between the classified adjacent named entities belong to predefined relation classes, then in step 509, de-replication and merging is performed on the relations between the classified adjacent named entities.

Repetitive relation information is firstly removed, and then the relation information is merged, for example, for relation information <IBM China Research Lab, located in, Haohai Building, 2003> and <IBM China Research Lab, located in, Diamond Building, 2005>, they are two relations with the same subjects and relation words, only with objects thereof having different values at different time, and thus they can be merged into <IBM China Research Lab, located in, (Haohai Building, 2003) (Diamond Building, 2005)>, which is data of relation information change history, including address information of IBM China Research Lab in different periods, and the data of the relation information change history is stored to the relation information change history database. Otherwise, the relation information will be discarded in step 508.

In step 511, information change data indices are established for the relations of the classified adjacent named entities after the de-replication and merging processing. In order to be able to obtain relation information change history data quickly, indexing thereof is to be done. Preferably, two kinds of indexing are performed. One is to establish indices for subject and object, and thus it can be retrieved from the adjacent named entities that “IBM China Research Lab” is in a relation of “located in” with “Haohai Building”; the other is to establish indices for subject and relation, and thus, historical changes as (Haohai Building, 2003) and (Diamond Building, 2005) can be obtained when (IBM China Research Lab, located in) is used as a condition for query based on the retrieved relation type results of the named entities. As for how to establish retrieve entries specifically, those skilled in the art can employ many existing technologies based on the invention, and no more description will be given here.

Thus, changes of the relation information between the named entities of the electronic document can be acquired quickly through retrieval. In step 513, the information change data indices are stored to the relation information change history database. As the electronic document will increase over time continuously and information within the electronic document will change continuously, the above steps 501-513 can be repeated regularly to ensure capability of providing timely changed information to the user, and the step is not explicitly shown in FIG. 5.

Content change prompting step 900 provides prompts of content changes of the electronic document to the user based on the relation information change history database established and changed in step 700. Herein, in step 514, a request of a client to browse a web page or other electronic document is responded, and in step 515, named entity recognition is first performed on the electronic document. For example, two named entities “IBM China Research Lab” and “Haohai Building” are extracted from the text. If these two named entities are very close, then in step 517, these two entities are transferred to the relation information change history database as search conditions for query, and then based on the established indices, relation quaternaries as <IBM China Research Lab, address (located in), Haohai Building, 2003> can be obtained, thereafter (IBM China Research Lab, address) is used as a search condition for query, a historical change of relations as (Haohai Building, 2003) (Diamond Building, 2005) can be obtained, then through steps 519 and 521, this change of relation information is returned to the user to remind that, since 2005, the address of IBM China Research Lab has been changed to “Diamond Building.”

This process can be computed and completed by network operators, search engines, or other application providers at the background in advance. It can be updated regularly, and can directly provide the change result thereof to the user based on the unique identifier of the electronic document when the user makes a request to browse the electronic document. Additionally and preferably, if the serving party itself owns the copyright of the electronic document, or the right of using the copyright, the electronic document can also combined with named entities of the electronic document by network operators, search engines, or other application providers at the background. Additionally and preferably, taking the number of electronic documents into account, update records can be established for electronic documents which are read by a large number of readers, (such as hot notes with high number of clicks on the Internet), in the relation information change history database, which will significantly reduce the burdens of background servers. Of course, named entity recognition can also be performed on the electronic document by plug-ins at the server side or the user side during the process in which the user makes a request for accessing the electronic document, and thus preparations at the background can be relatively reduced.

In addition to the above mentioned application example of the address change of IBM China Research Lab, FIG. 6 shows another specific application example of the present invention. FIG. 6 shows contents from an Internet blog, where “World Cup” and “Germany” are a part of named entities recognized from the blog and the second “World Cup” and “Germany” appear in the same sentence. By transferring the two named entities to the established relation information change history database at the background for retrieval, we can know that they both have a “Hosted By” relation, and then according to the retrieved “Hosted By” relation, by transferring “World Cup” and “Hosted By” to the background database for retrieval, a history change process of relation information can be acquired and then provided to the user. Taking friendliness of user interface into account, options are preferably set up in the user interface for the user to decide whether to use the function of the display change. A cursor following manner can also be employed in a document interface, and only when the user is interested in some contents, related changes are displayed, which can not only ensure the user gets changed information, but also cannot affect the user's ability to read the original text. In addition, the user can also define only displaying updates of some particular type of relation information between named entities of the electronic document; such as, for example, if the user is only concerned about changes of address, price, name and the like.

Preferably, links of related change contents can also be displayed to facilitate the user's further reading. Of course, those skilled in the art can employ other user favored display manners based on the present application.

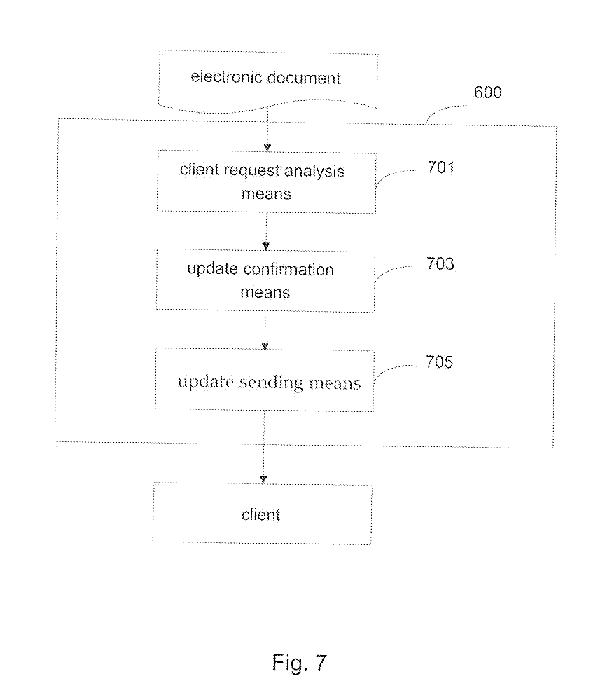

FIG. 7 shows a system 600 for prompting changes of electronic document content of the present invention. Herein, a client request analysis means 701 is configured to, in response to a request of a client to browse an electronic document, analyze the request to obtain related information; an update confirmation means 703 is configured to, based on the related information, determine whether there exist changes of relation information between at least a part of named entities of the electronic document; and an update sending means 705 is configured to, if there exist changes of the relation information, send at least a part of the changes of the relation information to the client. As implementations of the related method involved by the related means have been described in detail hereinabove, no more description will be given here.

Preferably, where, the client request analysis means 701 includes means configured to recognize at least a part of named entities of the electronic document.

Preferably, where, the update confirmation means 703 includes means configured to retrieve a relation information change history database to determine whether there exist changes of relation information between the named entities.

Preferably, where, the related information includes at least a part of named entities of the electronic document, and the update confirmation means 703 includes: means configured to retrieve a relation information change history database based on at least a part of named entities of the electronic document; and means configured to, if changes of relation information between the named entities are retrieved in the relation information change history database, determine that there exist changes of relation information between the named entities.

Preferably, where the related information includes unique identifier of the electronic document, and the update confirmation means 703 includes: means configured to retrieve a relation information change history database based on the unique identifier; and means configured to, if changes of relation information between the named entities are retrieved in the relation information change history database, determine that there exist changes of relation information between the named entities the electronic document.

Preferably, the system 600 for prompting changes of electronic document content further includes means configured to establish the relation information change history database, the means including: means configured to extract relation information between named entities of a plurality of the electronic documents, and means configured to establish a relation information change history database based on the relation information.

Preferably, the means configured to extract relation information between named entities of a plurality of the electronic documents include: means configured to receive a plurality of the electronic documents; means configured to recognize the named entities of the electronic documents; means configured to extract related features of adjacent named entities; and means configured to, based on the related features, classify relations between the adjacent named entities.

Preferably, where, the features include: native features of named entities; relation features of named entities; and context features of named entities.

Preferably, the means configured to establishing a relation information change history database based on the relation information includes: means configured to decide whether relations between the classified adjacent named entities belong to predefined relation classes; means configured to perform de-replication and merging on the relations between the classified adjacent named entities; means configured to establish relation information change data indices for the relations between the classified adjacent named entities after the de-replication and merging processing; and means configured to store the relation information change data indices to a relation information change history database.

Preferably, where, the means for establishing a relation information change history database further include means configured to collect electronic documents regularly to update the relation information change history database.

Preferably, where, the means configured to establish relation information change data indices for the relations between the classified adjacent named entities after the de-replication and merging processing include means configured to establish relation information change data indices with respect to at least one of named entities in the relation information, relations and the unique identifier of the electronic document.

Preferably, where, the unique identifier includes one of: URL of the electronic document, storage path of the electronic document, and global unique code of the electronic document. Where, the relation information includes named entities, relations between named entities, and time information.

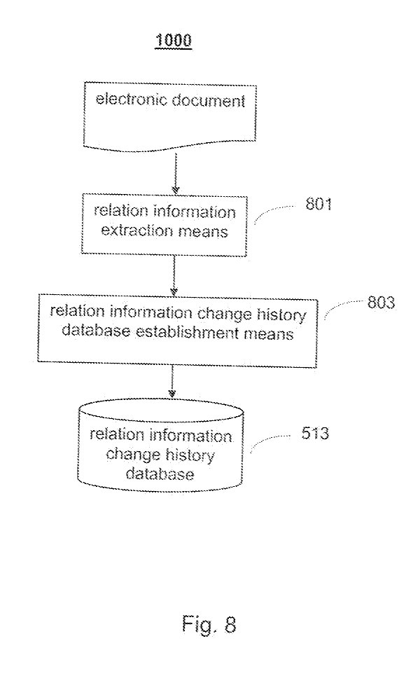

FIG. 8 shows a structural block diagram of a system 1000 for establishing the relation information change history database of the invention. The system 1000 includes relation extraction means 801 and relation information change history database establishment means 803. Among them, the relation extraction means 801 is configured to extract relation information between named entities of a plurality of the electronic documents; the relation information change history database establishment means 803 is configured to establish the relation information change history database based on the relation information. As implementations of the related method involved by the related means have been described in detail hereinabove, no more description will be given here.

Preferably, the relation extraction means 801 include: means configured to receiving a plurality of the electronic documents; means configured to recognizing the named entities in the electronic documents; means configured to extracting related features of adjacent named entities; and means configured to, based on the related features, classifying relations between the adjacent named entities.

Preferably, where, the features include: native features of named entities; relation features of named entities; and context features of named entities.

Preferably, the relation information change history database establishment means 803 include: means configured to decide whether relations between the classified adjacent named entities belong to predefined relation classes; means configured to perform de-replication and merging on the relations between the classified adjacent named entities; means configured to establish relation information change data indices for the relations between the classified adjacent named entities, after the de-replication and merging processing; and means configured to store the relation information change data indices to a relation information change history database.

Preferably, where, the relation information change history database establishment means 803 further include means configured to collecting electronic documents regularly to update the relation information change history database.

Preferably, where, the means configured to establishing relation information change data indices for the relations between the classified adjacent named entities after the de-replication and merging processing include means configured to establishing relation information change data indices with respect to at least one of named entities in the relation information, relations and the unique identifier of the electronic document.

In addition, the method for prompting changes of electronic document content and the method for establishing the relation information change history database according to the invention can also be implemented by a computer program product, the computer program product including software code portions executed for implementing the simulation method of the invention when the computer program product is run on a computer.

The invention can also be implemented by recording a computer program in a computer-readable recording medium, the computer program including software code portions executed for implementing the simulation method according to the invention when the computer program is run on a computer. That is, the processes of the simulation method according to the invention can be distributed in form of instructions in the computer-readable medium and in other forms, regardless specific types of signal bearing media actually used to perform distribution. Examples of the computer readable media include media such as EPROM, ROM, tape, paper, floppy disk, hard drive, RAM and CD-ROM as well as transmission-type media such as digital and analog communication links.

As it can be seen, on the one hand, the present invention can prompt updates of related electronic documents, especially outdated information on web electronic documents, to improve the quality of information on the World Wide Web, which is even more important in the Web 2.0 era. On the other hand, the present invention can further allow users to facilitate viewing information change history, which undoubtedly enhances user experience of reading electronic documents and efficiency for acquiring accurate information greatly.

Although the invention is specifically illustrated and described with reference to preferred embodiments of the invention, those of ordinary skill in the art should understand that various modifications thereof can be made in terms of form and detail, without departing from the spirit and scope of the invention defined by the appending claims.

We claim:

1. A method for prompting changes of electronic document content, the method comprising the steps of:
determining a first relation information from a first document wherein said first relation information comprises: (i) a first named entity, (ii) a second named entity and (iii) a first relationship between said first named entity and said second named entity;
storing said first relation information in a database;
determining a second relation information from a second document, wherein said second relation information comprises: (i) a third named entity, (ii) a fourth named entity and (iii) a second relationship between said third named entity and said fourth named entity.
retrieving said first relation information from said database; and
sending said first relation information to a client, if said first relation information is different from said second relation information;
wherein at least one step is carried out using a computer device.

2. The method according to claim 1, further comprising the steps of:
receiving a request from said client to view said first document; and
analyzing said request to obtain related information.

3. The method according to claim 2, wherein said related information comprises a unique identifier, and said sending step further comprises:
retrieving information contained in said database based on at least one of (i) a retrieved named entity selected from the group consisting of: (a) said first named entity, (b) said second named entity, (c) said third named entity and (d) said fourth named entity and (ii) a retrieved relationship information selected from the group consisting of: (a) said first relationship and (b) said second relationship.

4. The method according to claim 3, wherein said sending step further comprises determining whether there is a difference between said first relation information and said second relation information.

5. The method according to claim 4, further comprising the steps of:
extracting at least one feature that is common to at least two named entities selected from the group consisting of: (i) said first named entity, (ii) said second named entity, (iii) said third named entity and (iv) said fourth named entity; and
classifying at least one relationship between said at least two named entities based on said at least one related feature.

6. The method according to claim 5, wherein said at least two named entities are adjacent named entities.

7. The method according to claim 6, wherein said at least one common feature is selected from the group consisting of: (i) a native feature of said at least two adjacent named entities; (ii) a relation feature of said at least two adjacent named entities; and (iii) a context feature of said at least two adjacent named entities.

8. The method according to claim 5, wherein said extracting uses a method selected from the group consisting of: (i) Latent Dirichlet Allocation and (ii) grammar structure allocation.

9. The method according to claim 6, further comprising the steps of:
deciding whether said at least one relationship between said at least two classified adjacent named entities belongs to at least one predefined relationship class;
if said at least one relationship between said at least two classified adjacent named entities belongs to at least one predefined relationship class, then:
performing both de-replication and merging on said at least one relationship between said at least two classified adjacent named entities;
establishing a plurality of relation information change data indices for said at least one relationship between said at least two classified adjacent named entities after said de-replication and said merging occurs; and
storing said plurality of relation information change data indices to said database.

10. The method according to claim 1, further comprising the step of collecting at least one electronic document regularly to update said database.

11. The method according to claim 9, wherein said establishing step further comprises: establishing said plurality of relation information change data indices using at least one of: i) a selected named entity selected from the group consisting of a) said first named entity, b) said second named entity, c) said third named entity and d) said fourth named entity, ii) at least one selected relationship between at least two named entities selected from the group consisting of a) said first named entity, b) said second named entity, c) said third named entity and d) said fourth named entity and iii) said unique identifier.

12. The method according to claim 3, wherein said unique identifier comprises one of: i) a URL of said first document, ii) a storage path of said first document and iii) a global unique code of said first document.

13. The method according to claim 1, wherein said first relation information and said second relation information further comprise a time information.

14. An electronic data processing system for prompting changes of an electronic document, the system comprising:
determining means configured to determine: (i) a first relation information from a first document, wherein said first relation information comprises: (a) a first named entity, (b) a second named entity and (c) a first relationship between said first named entity and said second named entity and a (ii) a second relation information from a second document, wherein said second relation information comprises: (a) a third named entity, (b) a fourth named entity and (c) a relationship between said third named entity and said fourth named entity;
storing means configured to store said first relation information in a database;
retrieving means configured to retrieve said first relation information from said database; and
sending means configured to send said first relation information to a client, if said first relation information is different from said second relation information.

15. The electronic data processing system according to claim 14, further comprising:
receiving means configured to receive a request from said client to view said first document; and
analysis means configured to analyze said request to obtain related information.

16. The electronic data processing system according to claim 15, wherein said related information comprises a unique identifier, and said sending means further comprises:
retrieving means configured to retrieve information contained in said database based on at least one of: (i) a named entity selected from the group consisting of: (a) said first named entity, (b) said second named entity, (c) said third named entity and (d) said fourth named entity and (ii) a relationship information selected from the group consisting of: (a) said first relationship and (b) said second relationship.

17. The electronic data processing system according to claim 16, wherein said sending means further comprises determining means configured to determine whether there is a difference between said first relation information and said second relation information.

18. A computer readable storage medium tangibly embodying a computer readable program code having computer readable instructions which, when implemented, cause a computer to carry out the steps of the method according to claim 1.

19. A computer readable storage medium tangibly embodying a computer readable program code having computer readable instructions which, when implemented, cause a computer to carry out the steps of the method according to claim 2.

20. A computer readable storage medium tangibly embodying a computer readable program code having computer readable instructions which, when implemented, cause a computer to carry out the steps of the method according to claim 9.
